(19) United States
(12) Patent Application Publication
(10) Pub. No.: US 2025/0261583 A1
(43) Pub. Date: Aug. 21, 2025

(54) HARVESTER IMPLEMENT WITH IMPLEMENT HEAD HEIGHT DETERMINATION

(71) Applicant: DEERE & COMPANY, MOLINE, IL (US)

(72) Inventors: MOHAN A. VADNERE, PUNE (IN); SOURABHA S. GOKHALE, ICHALKARANJI (IN); Sameer Gorivale, PUNE (IN); Darin L. Roth, Mount Pleasant, IA (US)

(21) Appl. No.: 18/444,819

(22) Filed: Feb. 19, 2024

(51) Int. Cl. A01D 34/00; A01D 34/54; A01D 47/00

(52) U.S. Cl. CPC A01D 34/006; A01D 34/54; A01D 47/00

(57) ABSTRACT

A harvester implement includes a first motion sensor mounted on a traction unit at a location defining a traction unit elevation datum, and a second motion sensor mounted on an implement head at a location defining a head elevation datum. The implement head defines a head spacing between the head elevation datum and a ground contact surface of the implement head. An implement controller determines an offset distance between the traction unit elevation datum and the head elevation datum based on data from the first motion sensor related to movement of the traction unit and data from the second motion sensor related to movement of the implement head. The controller may then calculate a head height between the ground surface and the ground contact surface of the implement head by subtracting the offset distance and the head spacing from the traction unit elevation datum.

### BACKGROUND

A harvester implement may be configured to receive or connect to an implement or implement head for performing a harvest operation. One example of such a harvester implement may include a self-propelled windrower implement having a traction unit and a mower head attached to a forward end of the traction unit. An implement linkage system moveably connects the implement head to a frame of the traction unit. The implement linkage system is operable to raise or lift the implement head relative to the frame.

The harvester implement and the attached implement head may be configured to cut different crop materials. The crop materials may include but are not limited to forages and grains. Because the crop materials have different characteristics, the implement linkage system and implement head may have to be positioned differently for harvesting different crop materials. For example, the implement linkage system may raise the implement head to an uppermost elevation for transport, may position the implement head at an intermediate elevation for harvesting some crop materials, and may position the implement head on or immediately adjacent to the ground surface for harvesting other crop materials.

The implement linkage system may be operated in a height control operating condition, in which a position of the implement linkage system is actively controlled to control a height of the implement head relative to the frame. The height control operating condition may be used to raise the implement head into the transport position, or maintain the implement head at a fixed harvest height so that the implement head maintains a fixed height or position relative to the frame. The implement linkage system may alternatively be operated in a float operating condition in which the implement linkage system is allowed to move vertically relative to the frame to track the ground surface as the harvester implement travels across the ground surface.

When transitioning the operation of the implement linkage system from the height control operating condition to the float operating condition, it is important to know the position of the implement head relative to the ground surface, e.g., the height or elevation of the implement head relative to the ground surface, so that the implement linkage system may be transitioned from the height control operating condition to the float operating condition prior to the implement head contacting the ground surface.

### SUMMARY

A harvester implement is provided. The harvester implement includes a traction unit having a frame. The traction unit is configured for movement across a ground surface. The harvester implement includes a first motion sensor mounted on the traction unit at a location defining a traction unit elevation datum. The first motion sensor is configured for detecting data related to movement of the traction unit. An implement linkage system is coupled to the frame. The implement linkage system is configured for movement relative to the frame. An implement head is attached to and supported by the implement linkage system. The implement linkage system is operable to move the implement head relative to the frame to change an elevation of the implement head relative to the ground surface. A second motion sensor is mounted on the implement head at a location defining a head elevation datum. The second motion sensor is configured for detecting data related to movement of the implement head. The implement head defines a head spacing between the head elevation datum and a ground contact surface of the implement head. The harvester implement further includes an implement controller including a processor and a memory having a head height determination algorithm stored thereon. The processor is operable to execute the head height determination algorithm to determine an offset distance between the traction unit elevation datum and the head elevation datum based on data from the first motion sensor related to movement of the traction unit and data from the second motion sensor related to movement of the implement head. Calculate a head height between the ground surface and the ground contact surface of the implement head by subtracting the offset distance and the head spacing from the traction unit elevation datum. The implement controller may then control the implement linkage system based on the implement head elevation.

In one aspect of the disclosure, the first motion sensor may include, but is not limited to, an accelerometer operable to measure acceleration in at least the vertical direction, and optionally also in a fore-aft horizontal direction and a left-right horizontal direction. Similarly, the second motion sensor may include, but is not limited to, an accelerometer operable to measure acceleration in at least the vertical direction, and optionally also in the fore-aft horizontal direction and the left-right horizontal direction. It should be appreciated that the first motion sensor and the second motion sensor may be implemented differently than the example implementation of an accelerometer noted herein.

In one aspect of the disclosure, the processor may be operable to execute the head height determination algorithm to determine a pitch angle between the implement head and the frame. The implement controller may determine the pitch angle based on data from the first motion sensor related to movement of the traction unit and data from the second motion sensor related to movement of the implement head. As used herein, the “pitch angle” is defined the angle of the implement head about a central transverse axis of the implement head relative to a horizontal plane. The central transverse axis of the implement head is generally horizontal and perpendicular to a central longitudinal axis of the traction unit. In one aspect of the disclosure, the processor may be operable to execute the head height determination algorithm to adjust the implement head height based on the pitch angle.

In one aspect of the disclosure, the processor may be operable to execute the head height determination algorithm to determine a roll angle of the implement head relative to the frame. The implement controller may determine the roll angle based on data from the first motion sensor related to movement of the traction unit and data from the second motion sensor related to movement of the implement head. As used herein, the “roll angle” is defined as the angle of the implement head about the central longitudinal axis of the traction unit relative to the horizontal plane. The central longitudinal axis of the traction unit is generally horizontal and extends between a forward end and a rearward end of the frame. In one aspect of the disclosure, the processor may be operable to execute the head height determination algorithm to adjust the implement head height based on the roll angle.

In one aspect of the disclosure, the traction unit may include an inflatable tire supporting the frame relative to the ground surface. The traction unit ma further include a tire pressure sensor configured for sensing a tire pressure of the inflatable tire. The processor may be operable to execute the head height determination algorithm to identify a change in the tire pressure of the inflatable tire based on data sensed by the tire pressure sensor, and adjust the traction unit elevation datum based on the change in the tire pressure.

In one aspect of the disclosure, the implement head includes a mower mounted to a forward end of the frame. The mower includes a blade defining the ground contact surface of the implement head. The mower may include, but is not limited to, a rotary bar cutter head as is understood by those skilled in the art. However, in other implementations, the implement head may be configured differently than the example mower head described herein.

In one aspect of the disclosure, the implement linkage system may include a hydraulic cylinder that is selectively controllable between a float operating condition and a height control operating condition. When the hydraulic cylinder is disposed in the float operating condition, the implement linkage system is allowed to move vertically relative to the frame to track the ground surface as the harvester implement moves across the ground surface. When the hydraulic cylinder is disposed in the height control operating condition, a length of the hydraulic cylinder is actively controlled to raise the implement head relative to the frame and/or maintain a fixed position of the implement head relative to the frame.

In one aspect of the disclosure, the processor may be operable to execute the head height determination algorithm to control the implement linkage system, and the hydraulic cylinder thereof, between one of the float operating condition and the height control operating condition, based on the implement head elevation.

Accordingly, the implement controller may determine the implement head elevation from data from the first motion sensor and the second motion sensor, from which the implement controller may then accurately control the implement linkage system, for example, when changing between the height control operating condition and the float operating condition.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a harvester implement.

FIG. 2 is a schematic plan view of the harvester implement.

FIG. 3 is a schematic drawing of a hydraulic system of the harvester implement.

FIG. 4 is a schematic perspective view of an implement linkage system of the harvester implement.

FIG. 5 is a schematic side view of the harvester implement.

FIG. 6 is a schematic front view of an implement head of the harvester implement showing a roll angle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

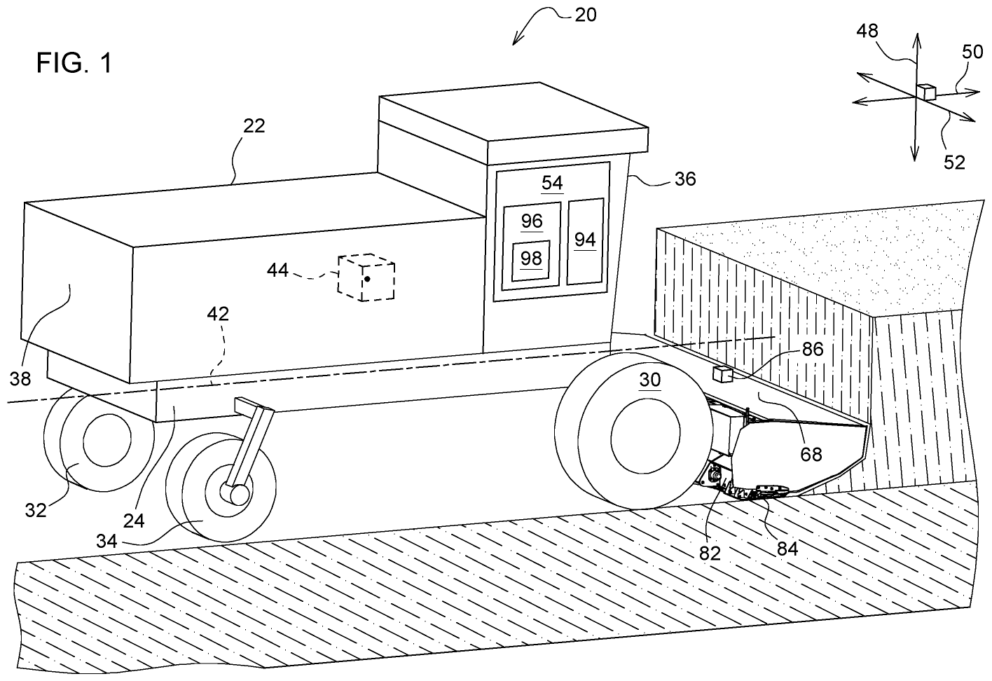

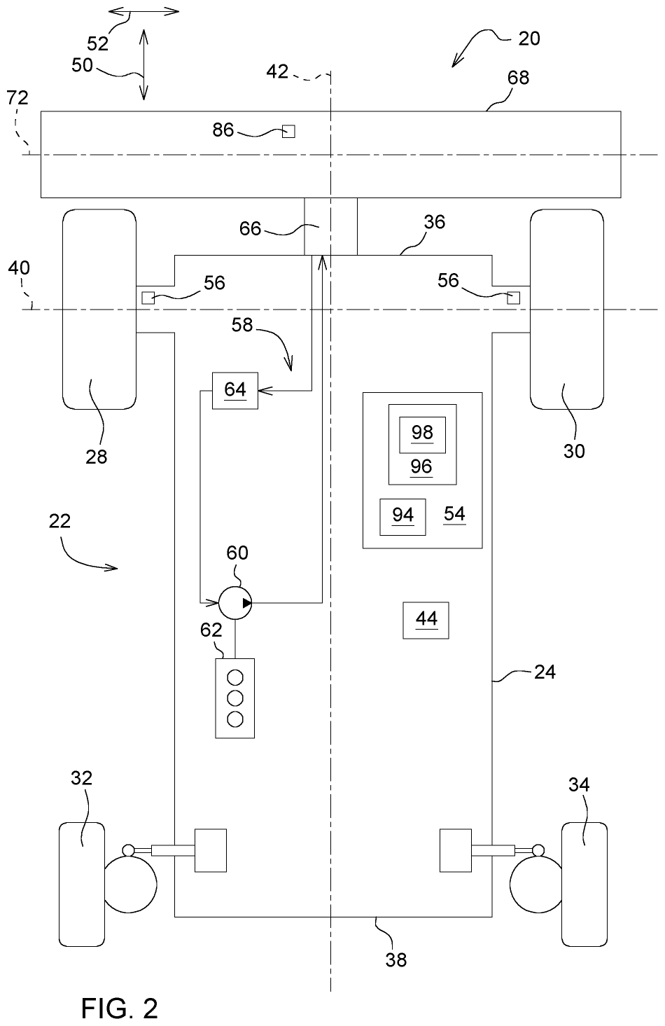

Referring to the Figures, wherein like numerals indicate like parts throughout the several views, a harvester implement is generally shown at 20. Referring to FIGS. 1-2, the example implementation of the harvester implement 20 is configured as a mower implement, particularly as a self-propelled windrower. However, it should be appreciated that the teachings of this disclosure may be applied to crop harvesting machines other than the example self-propelled windrower depicted in the Figures.

Referring to FIGS. 1-2, the harvester implement 20 includes a traction unit 22 having a frame 24. The traction unit 22 is configured for movement across a ground surface 26 of a field to harvest crop material. The frame 24 supports a prime mover 62. The prime mover 62 may include, but is not limited to, an internal combustion engine, an electric motor, a combination of both, or some other device capable of generating a primary source of power for the harvester implement 20.

In the example implementation shown in the Figures, a left front drive wheel 28 and a right front drive wheel 30 are each mounted to the frame 24, adjacent a forward end 36 of the frame 24. The left front drive wheel 28 and the right front drive wheel 30 are rotatable about a transverse drive axis 40. The transverse drive axis 40 is generally horizontal and perpendicular to a central longitudinal axis 42 of the frame 24. The central longitudinal axis 42 of the frame 24 extends between the forward end 36 of the frame 24 and a rearward end 38 of the frame 24.

The traction unit 22 may include a differential drive system. As understood by those skilled in the art, with reference to the differential drive system, the left front drive wheel 28 and the right front drive wheel 30 may be simultaneously rotated in the same rotational direction and at the same rotational speed about the transverse drive axis 40 to drive the harvester implement 20 forward or rearward, depending upon the direction of rotation. Additionally, the left front drive wheel 28 and the right front drive wheel 30 may be rotated in the same rotational direction at different rotational speeds about the transverse drive axis 40, or in opposite rotational directions at the same or different rotational speeds about the transverse drive axis 40, in order to turn the harvester implement 20.

Referring to FIGS. 1-2, the example implementation of the harvester implement 20 further includes a left rear caster wheel 32 and a right rear caster wheel 34 attached to the frame 24. As used herein, the term “caster wheel” should be understood to include a wheel that is able to rotate a full three hundred sixty degrees (360°) about a respective generally vertical axis. As such, each of the left rear caster wheel 32 and the right rear caster wheel 34 are rotatable a full three hundred sixty degrees (360°) about a respective generally vertical axis. The left rear caster wheel 32 and the right rear caster wheel 34 may be attached to the frame 24 in a suitable manner. The specific manner in which the left rear caster wheel 32 and the right rear caster wheel 34 are attached to the frame 24 is not pertinent to the teachings of this disclosure, are understood by those skilled in the art, and are therefore not described in detail herein.

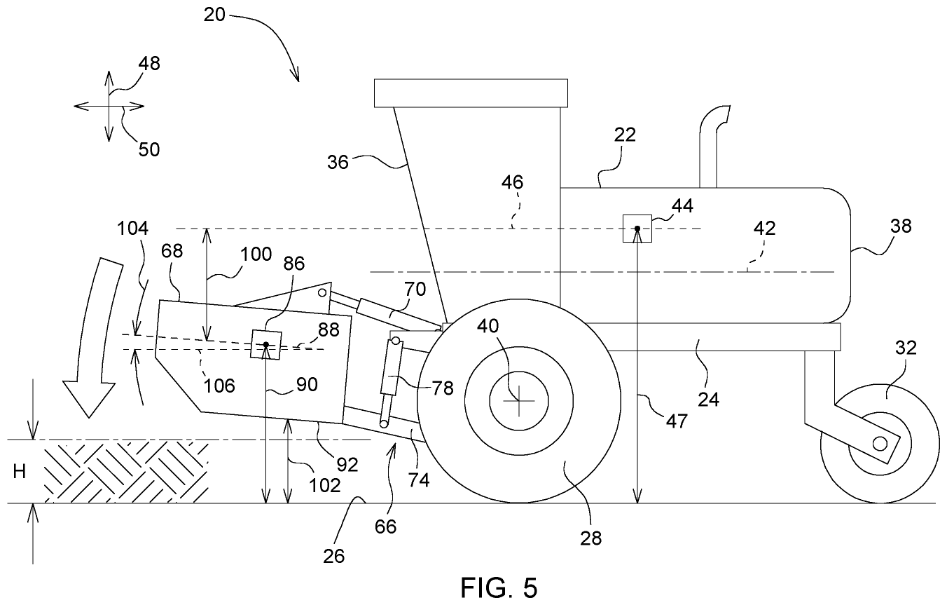

Referring to FIG. 5, the traction unit 22 includes a first motion sensor 44 that is mounted on the traction unit 22. The first motion sensor 44 is mounted on the traction unit 22 at a location defining a traction unit elevation datum 46. The traction unit elevation datum 46 defines a height or distance 47 between the location at which the first motion sensor 44 is attached to the traction unit 22 and the ground surface 26. The first motion sensor 44 is configured for detecting data related to movement of the traction unit 22. In one implementation, the first motion sensor 44 includes an accelerometer operable to measure acceleration of the traction unit 22. The first motion sensor 44 may be configured to measure and/or detect acceleration in at least a vertical direction 48. The first motion sensor 44 may further be configured to measure and/or detect acceleration in a fore-aft direction 50 along the central longitudinal axis 42 of the frame 24, and/or in a left-right direction 52 along the transverse drive axis 40. The accelerometer of the first motion sensor 44 may include for example, but is not limited to, a piezoelectric accelerometer that is operable to send an electrical signal in response to acceleration of the sensor, a piezoresistive accelerometer that is operable to vary an electrical resistance based on the acceleration of the sensor, a capacitive accelerometer that is operable to change an electrical capacitance based on the acceleration of the sensor, or some other device capable of communicating a signal indicative of acceleration of the traction unit 22 to an implement controller 54. The specific types, features, configuration and/or operation of the accelerometer of the first motion sensor 44 are understood by those skilled in the art, and are therefore not described in greater detail herein.

Referring to FIG. 2, the traction unit 22 may include a pneumatic tire, i.e., an inflatable tire 28, 30, 32, 34 supporting the frame 24 relative to the ground surface 26. For example, one or more of the left front drive wheel 28, right front drive wheel 30, left rear caster wheel 32, and/or right rear caster wheel 34 may be implemented as an inflatable tire 28, 30, 32, 34. As is understood by those skilled in the art, the inflatable tire 28, 30, 32, 34 is filled with a pressurized gas, e.g., air or nitrogen. The height of a center of the respective inflatable tire 28, 30, 32, 34 is dependent upon the gas pressure within the inflatable tire 28, 30, 32, 34. The traction unit 22 may include a respective a tire pressure sensor 56 configured for sensing pressure within the inflatable tire 28, 30, 32, 34 for each respective tire/wheel. The respective tire pressure sensor 56 for each respective tire/wheel may communicate a signal to the implement controller 54 indicating the current tire pressure of that respective tire/wheel. The specific features, components and operation of the tire pressure sensor 56 are understood by those skilled in the art, are not pertinent to the teachings of this disclosure, and are therefore not described in greater detail herein.

In one aspect of the disclosure, the harvester implement 20 may include a wheel suspension system connecting the wheels 28, 30, 32, 34 and the frame 24. The wheel suspension system may be configured to allow movement of the frame 24 relative to the ground surface 26 as is understood by those skilled in the art. The wheel suspension system may include, but is not limited to, an independent wheel suspension system wherein each wheel is independently supported and independently moveable relative to the frame. The wheel suspension system may include, for example, a spring, a shock, a linkage systems, etc., as is understood by those skilled in the art. The harvester implement 20 may include a position sensor positioned to sense data related to a position of the wheel suspension system relative to the frame 24 and/or the ground surface 26 at one or more of the wheels 28, 30, 32, 34.

Referring to FIGS. 2-4, the harvester implement 20 includes a hydraulic system 58. The hydraulic system 58 includes a pressure source 60 configured to supply a flow of pressurized fluid. The pressure source 60 may include, but is not limited to, a fluid pump that is drivenly coupled to the prime mover 62. The pressure source 60 draws fluid from a tank 64, and circulates the fluid through a fluid circuit. The tank 64 receives the fluid from the fluid circuit, stores the fluid, and supplies the fluid to the pressure source 60, e.g., the fluid pump. Fluid flow and/or pressure from the fluid pump may be used to operate various components of the harvester implement 20, as described in greater detail below. It should be appreciated that the hydraulic system 58 may include other components not specifically mentioned herein, such as but not limited to one or more hydraulic control valves, accumulators, pressure sensors, etc.

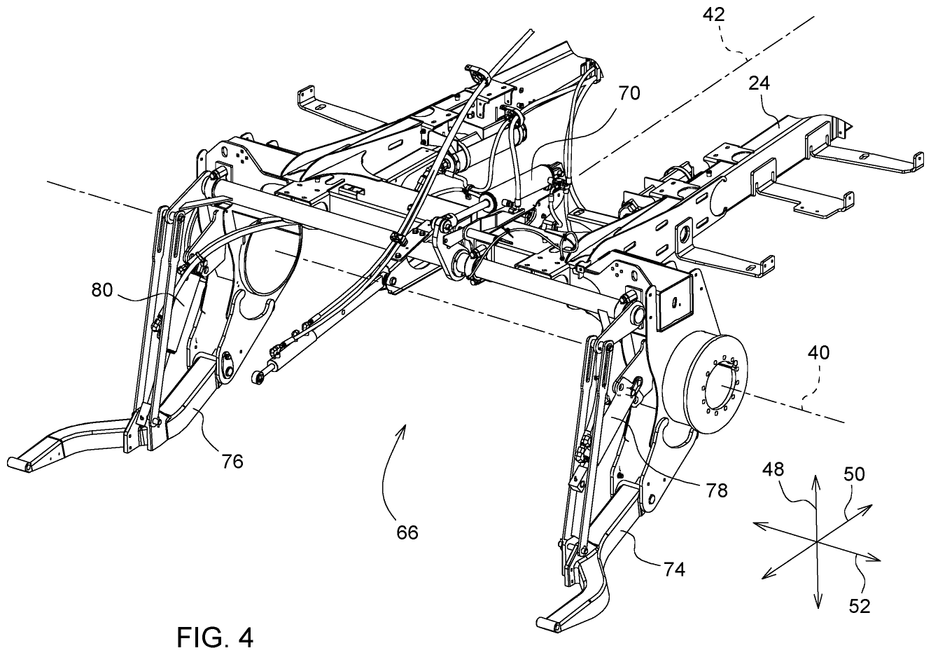

Referring to FIG. 4, the harvester implement 20 includes an implement linkage system 66 attached and/or coupled to the frame 24. In the example implementation shown in FIG. 4, the implement linkage system 66 is disposed adjacent the forward end 36 of the frame 24. However, in other implementations, the implement linkage system 66 may be disposed adjacent the rearward end 38 of the frame 24. The implement linkage system 66 is configured for movement relative to the frame 24, and is further configured for attaching an implement head 68 to the frame 24. The implement head 68 is attached to and supported by the implement linkage system 66. The implement linkage system 66 is operable to move the implement head 68 relative to the frame 24 to change an elevation of the implement head 68 relative to the ground surface 26.

The hydraulic system 58 is configured for operating the implement linkage system 66 in a float operating condition and a height control operating condition. When the hydraulic system 58 is configured to operate the implement linkage system 66 in the float operating condition, the implement linkage system 66 is allowed to move vertically relative to the frame 24, as the harvester implement 20 moves across the ground surface 26, so that the implement head 68 may track or follow the vertical undulations and changes in the ground surface 26. When the hydraulic system 58 is configured to operate in the height control operating condition, the implement linkage system 66 may be controlled to actively raise and/or lower the implement head 68 relative to the frame 24, or may be controlled to maintain a vertical position of the implement head 68 relative to the frame 24 as the harvester implement 20 moves across the ground surface 26.

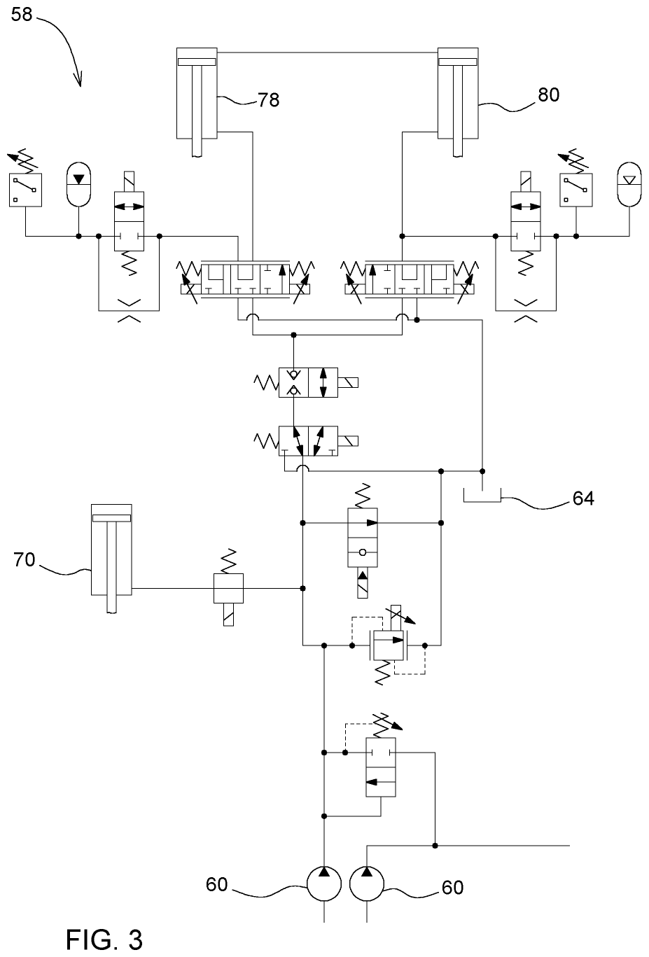

Referring to FIGS. 3-4, the hydraulic system 58 includes a tilt cylinder 70. The tilt cylinder 70 is attached to and interconnects the frame 24 and the implement head 68 attached to the implement linkage system 66. The tilt cylinder 70 is operable to rotate the implement head 68 attached to the implement linkage system 66 about a central transverse axis 72 of the implement head 68 relative the ground surface 26. The central transverse axis 72 of the implement head 68 may be defined as a tilt axis, and extends transverse to the central longitudinal axis 42 of the frame 24 and through distal ends of a left connecting arm 74 and a right connecting arm 76. In the example implementation described herein, the tilt cylinder 70 is a double acting hydraulic cylinder in fluid communication with the hydraulic system 58. In other embodiments, the tilt cylinder 70 may include a single acting hydraulic cylinder, an electrically actuated linear actuator, or some other device capable of extending and retracting. The tilt cylinder 70 extends and retracts in response to fluid pressure and/or flow from the hydraulic system 58 in the usual manner as understood by those skilled in the art.

Referring to FIGS. 3-4, the implement linkage system 66 further includes a hydraulic cylinder, e.g., a left lift/float cylinder 78 and a right lift/float cylinder 80, that is selectively controllable between the float operating condition in which the implement linkage system 66 is allowed to move vertically relative to the frame 24 to track the ground surface 26 as the harvester implement 20 moves across the ground surface 26, and the height control operating condition wherein a respective length of the left lift/float cylinder 78 and the right lift/float cylinder 80 is actively controlled to control the position of the implement head 68 relative to the frame 24. As noted above, the implement linkage system 66 includes the left connecting arm 74 and the right connecting arm 76. The left connecting arm 74 is rotatably attached to the frame 24 on a left side of the frame 24. The left lift/float cylinder 78 is attached to and interconnects the frame 24 and the left connecting arm 74. The right connecting arm 76 is rotatably attached to the frame 24 on a right side of the frame 24. The right lift/float cylinder 80 is attached to and interconnects the frame 24 and the right connecting arm 76.

In the example implementation shown in the Figures and described herein, the left lift/float cylinder 78 and the right lift/float cylinder 80 are each a double acting hydraulic cylinder. As is understood by those skilled in the art, a double acting hydraulic cylinder includes a fluid port disposed at each axial end thereof. Fluid pressure may be applied to one end of the hydraulic cylinder to control extension of the hydraulic cylinder, whereas fluid pressure may be applied to an opposite end of the hydraulic cylinder to control retraction of the hydraulic cylinder.

The implement head 68 may include, but is not limited to, a rotary cutter bar 82 having a plurality of mower blades 84 rotatably mounted on the cutter bar 82, such as shown in FIG. 1. It should be appreciated that the implement head 68 may include some other type of crop harvesting head not specifically mentioned and/or described herein. Additionally, while the example implementation of the harvester implement 20 includes the implement head 68 attached adjacent the forward end 36 of the frame 24, it should be appreciated that the teachings of this disclosure may be applied to other implementations of the harvester implement 20, including those in which the harvester head is attached adjacent the rearward end 38 of the frame 24 of the harvester implement 20, such as but not limited to a drawn mower conditioner or a baler implement.

Referring to FIG. 5, the implement head 68 includes a second motion sensor 86 that is mounted on the implement head 68. The second motion sensor 86 is mounted on the implement head 68 at a location defining a head elevation datum 88. The head elevation datum 88 defines a head spacing 90 between the location at which the second motion sensor 86 is attached to the implement head 68 and a ground contact surface 92 of the implement head 68. The ground contact surface 92 of the implement head 68 may be defined to include a lower surface of the implement head 68 that may contact or engage the ground surface 26. For example, if the implement head 68 is configured as the rotary cutter bar 82 mounted to the forward end 36 of the frame 24, the ground contact surface 92 of the implement head 68 may be defined by the elevation of the mower blades 84 of the rotary cutter bar 82. It should be appreciated that the head spacing 90 is a fixed distance defined between the head elevation datum 88 and the ground contact surface 92, which is dependent upon the particular implementation and/or configuration of the implement head 68.

The second motion sensor 86 is configured for detecting data related to movement of the implement head 68. In one implementation, the second motion sensor 86 includes an accelerometer operable to measure acceleration. The second motion sensor 86 may be configured to measure and/or detect acceleration of the implement head 68 in at least the vertical direction 48. The second motion sensor 86 may further be configured to measure and/or detect acceleration in the fore-aft direction 50 along the central longitudinal axis 42 of the frame 24, and/or in the left-right direction 52 along the central transverse axis 72 of the implement head 68. The accelerometer of the second motion sensor 86 may include for example, but is not limited to, a piezoelectric accelerometer that is operable to send an electrical signal in response to acceleration of the sensor, a piezoresistive accelerometer that is operable to vary an electrical resistance based on the acceleration of the sensor, a capacitive accelerometer that is operable to change an electrical capacitance based on the acceleration of the sensor, or some other device capable of communicating a signal indicative of acceleration of the implement head 68 to the implement controller 54. The specific types, features, configuration and/or operation of the accelerometer of the second motion sensor 86 are understood by those skilled in the art, and are therefore not described in greater detail herein.

The implement controller 54 is disposed in communication with the first motion sensor 44, the second motion sensor 86, and the components of the hydraulic system 58 for controlling the implement linkage system 66. The implement controller 54 is operable to receive data signals from the first motion sensor 44 and the second motion sensor 86, and communicate control signals to the components of hydraulic system 58 for controlling the implement linkage system 66. While the implement controller 54 is generally described herein as a singular device, it should be appreciated that the implement controller 54 may include multiple devices linked together to share and/or communicate information therebetween. Furthermore, it should be appreciated that the implement controller 54 may be located on the traction unit 22, the implement head 68, and/or be located remotely from the harvester implement 20.

The implement controller 54 may alternatively be referred to as a computing device, a computer, a controller, a control unit, a control module, a module, etc. The implement controller 54 includes a processor 94, a memory 96, and all software, hardware, algorithms, connections, sensors, etc., necessary to manage and control the operation of the harvester implement 20 as described herein. As such, a method may be embodied as a program or algorithm operable on the implement controller 54. It should be appreciated that the implement controller 54 may include any device capable of analyzing data from various sensors, comparing data, making decisions, and executing the required tasks.

As used herein, “controller” is intended to be used consistent with how the term is used by a person of skill in the art, and refers to a computing component with processing, memory, and communication capabilities, which is utilized to execute instructions (i.e., stored on the memory 96 or received via the communication capabilities) to control or communicate with one or more other components. In certain embodiments, the implement controller 54 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The implement controller 54 may be in communication with other components on the harvester implement 20, such as hydraulic components, electrical components, and operator inputs within an operator station of the traction unit 22. The implement controller 54 may be electrically connected to these other components wirelessly or by a wiring harness such that messages, commands, and electrical power may be transmitted between the implement controller 54 and the other components. Although the implement controller 54 is referenced in the singular, in alternative embodiments the configuration and functionality described herein can be split across multiple devices using techniques known to a person of ordinary skill in the art.

The implement controller 54 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 96 may include any non-transitory/tangible medium which participates in providing data or computer-readable instructions. The memory 96 may be non-volatile or volatile. Non-volatile media may include, for example, optical or magnetic disks and other persistent memory. Example volatile media may include dynamic random access memory (DRAM), which may constitute a main memory. Other examples of embodiments for the memory 96 include a floppy, flexible disk, or hard disk, magnetic tape or other magnetic medium, a CD-ROM, DVD, and/or any other optical medium, as well as other possible memory devices such as flash memory.

The implement controller 54 includes the tangible, non-transitory memory 96 on which are recorded computer-executable instructions, including a head height determination algorithm 98. The processor 94 of the implement controller 54 is configured for executing the head height determination algorithm 98. The head height determination algorithm 98 implements a method of controlling the harvester implement 20, described in detail below.

The implement controller 54 may be configured to identify a change in the tire pressure of the inflatable tire 28, 30, 32, 34, i.e., one or more of the left front drive wheel 28, right front drive wheel 30, left rear caster wheel 32, and/or right rear caster wheel 34, based on data sensed by the respective tire pressure sensor 56 associated with the respective inflatable tire 28, 30, 32, 34. It should be appreciated that the elevation of a center of the inflatable tire 28, 30, 32, 34 relative to the ground surface 26 may vary with a variation in the tire pressure. For example, a decrease in tire pressure may be associated with a decrease in height of the center of the inflatable tire 28, 30, 32, 34 relative to the ground surface 26. A change in the height of the center of the tire may result in a change in the distance 47 between the ground surface 26 and the traction unit elevation datum 46. For example, a decrease in the height of the center of the tire, caused by a reduction in the tire pressure, may reflect a decrease in the traction unit elevation datum 46, i.e., a decrease in the distance 47 between the traction unit elevation datum 46 and the ground surface 26.

The implement controller 54 may adjust the traction unit elevation datum 46 based on the detected change in the tire pressure. For example, a relative increase in the tire pressure, i.e., a positive change in the tire pressure, may be associated with an increase in the traction unit elevation datum 46, whereas a relative decrease in the tire pressure, i.e., a negative change in the tire pressure, may be associated with a decrease in the traction unit elevation datum 46. The implement controller 54 may change or adjust the traction unit elevation datum 46 proportionally to the change in tire pressure, such that the traction unit elevation datum 46, i.e., the distance 47 between the location at which the first motion sensor 44 is attached to the traction unit 22 and the ground surface 26, is adjusted to account for a change in the height of the tire caused by changes to the tire pressure.

The implement controller 54 may adjust the traction unit elevation datum 46 based on the detected change in the position of the wheel suspension. For example, a lowered relative position of the wheel suspension system may be associated with a decrease in the traction unit elevation datum 46, whereas a raised or extended relative position of the wheel suspension system may be associated with an increase in the traction unit elevation datum 46. The implement controller 54 may change or adjust the traction unit elevation datum 46 proportionally to the change in position of the wheel suspension system, based on data detected by the suspension system position sensor, such that the traction unit elevation datum 46, i.e., the distance 47 between the location at which the first motion sensor 44 is attached to the traction unit 22 and the ground surface 26, is adjusted to account for a change in the position of the frame 24 caused by movement of the wheel suspension system relative to the ground surface 26.

During operation of the harvester implement 20, during which the harvester implement 20 moves across the ground surface 26, the first motion sensor 44 and the second motion sensor 86 detect and communicated data related to the acceleration of the traction unit 22 and the implement head 68 respectively to the implement controller 54.

The implement controller 54 is configured to determine an offset distance 100 between the traction unit elevation datum 46 and the head elevation datum 88 based on data from the first motion sensor 44 related to movement of the traction unit 22 and data from the second motion sensor 86 related to movement of the implement head 68. The offset distance 100 may be determined in any suitable manner. In one example implementation, the offset distance 100 may be determined by calculating the difference between the distance traveled by the traction unit 22 and the distance traveled by the implement head 68 over a period of time. The distance traveled by the traction unit 22 may be calculated from the equation:

Distance=(0.5)×(acceleration)×(time^2),

wherein the acceleration is the acceleration measured by the first motion sensor 44 over a period of time, and the time is the duration of time over which the acceleration was sensed. Similarly, the distance traveled by the implement head 68 may be calculated from the equation:

Distance=(0.5)×(acceleration)×(time^2),

wherein the acceleration is the acceleration measured by the second motion sensor 86 over a period of time, and the time is the duration of time over which the acceleration was sensed. It should be appreciated that the offset distance 100 may be calculated based on the data sensed by the first motion sensor 44 related to acceleration of the traction unit 22 and the second motion sensor 86 related to acceleration of the implement head 68 in some other manner not specifically described herein.

Once the offset distance 100 has been determined by the implement controller 54, the implement controller 54 may then calculate a head height 102. The head height 102 is defined herein as the distance between the ground surface 26 and the ground contact surface 92 of the implement head 68. Because the traction unit elevation datum 46 is known and establishes a fixed distance 47 between the first motion sensor 44 and the ground surface 26, and the head spacing 90 is known based on the particular implementation and dimensions of the implement head 68, the implement controller 54 may calculate or otherwise determine the head height 102 by subtracting the offset distance 100 and the head spacing 90 from the traction unit elevation datum 46.

The implement controller 54 may then control the implement linkage system 66 based on the implement head 68 elevation, i.e., the head height 102. For example, the implement controller 54 may control the implement linkage system 66, i.e., the left lift/float cylinder 78 and/or the right lift/float cylinder 80, between one of the float operating condition and the height control operating condition based on the implement head 68 elevation. For example, when lowering the implement head 68 toward the ground surface 26, the implement controller 54 may operate the fluid circuit in the height control operating condition to move the implement head 68 quickly toward the ground surface 26, and then switch operating conditions from the height control operating condition to the float operating condition as the implement head 68 nears the ground surface 26, based on the calculated implement head 68 elevation, i.e., the head height 102. By doing so, the implement head 68 is not forced into the ground surface 26 by the left lift/float cylinder 78 and the right lift/float cylinder 80 operating under the height control operating condition.

In one implementation, the implement controller 54 may determine a pitch angle 104 between the implement head 68 and the frame 24 based on data from the first motion sensor 44 related to movement of the traction unit 22 and/or data from the second motion sensor 86 related to movement of the implement head 68. As used herein, the “pitch angle 104” is defined as the angle of the implement head 68 about the central transverse axis 72 of the implement head 68 relative to a horizontal plane 106. The process in which the implement controller 54 may determine or calculate the pitch angle 104 of the implement head 68 based on three axis acceleration of the implement head 68 sensed by the second motion sensor 86 is understood by those skilled in the art, and is therefore not described in greater detail herein.

The implement controller 54 may then adjust and/or modify the calculated implement head 68 height based on the pitch angle 104. It should be appreciated that a change in the pitch angle 104 of the implement head 68 relative to the frame 24 of the traction unit 22 may result in a corresponding change in the head height 102. As such, the implement controller 54 may correct the calculated head height 102 based on a change in the pitch angle 104 to more accurately determine the head height 102 and thereby more accurately control the operation of the implement linkage system 66.

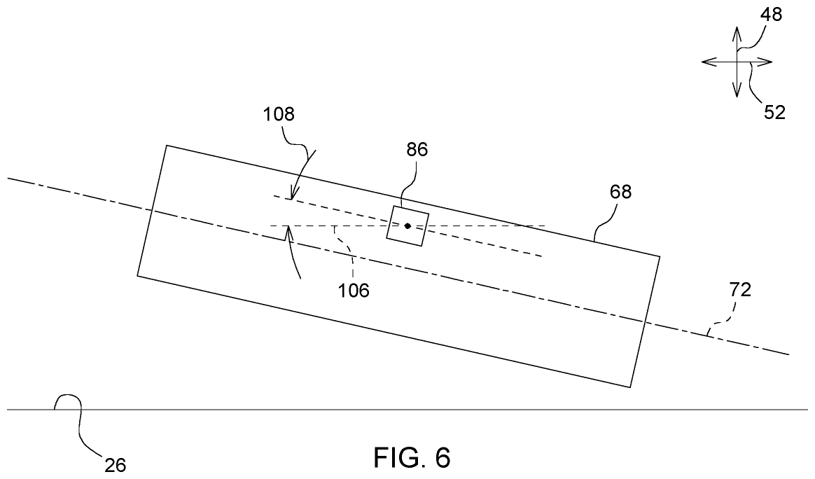

In one implementation, referring to FIG. 6, the implement controller 54 may determine a roll angle 108 between the implement head 68 and the frame 24 based on data from the first motion sensor 44 related to movement of the traction unit 22 and/or data from the second motion sensor 86 related to movement of the implement head 68. As used herein, the “roll angle 108” is defined as the angle of the implement head 68 about the central longitudinal axis 42 of the traction unit 22 relative to the horizontal plane 106. The process in which the implement controller 54 may determine or calculate the roll angle 108 of the implement head 68 based on three axis acceleration of the implement head 68 sensed by the second motion sensor 86, i.e., acceleration in the vertical direction 48, acceleration in the fore-aft direction 50, and acceleration in the left-right direction 52, is understood by those skilled in the art, and is therefore not described in greater detail herein.

The implement controller 54 may then adjust and/or modify the calculated implement head 68 height based on the roll angle 108. It should be appreciated that a change in the roll angle 108 of the implement head 68 relative to the frame 24 of the traction unit 22 may result in a corresponding change in the head height 102. As such, the implement controller 54 may correct the calculated head height 102 based on a change in the roll angle 108 to more accurately determine the head height 102 and thereby more accurately control the operation of the implement linkage system 66.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A harvester implement comprising:
a traction unit having a frame, wherein the traction unit is configured for movement across a ground surface;
a first motion sensor mounted on the traction unit at a location defining a traction unit elevation datum, wherein the first motion sensor is configured for detecting data related to movement of the traction unit;
an implement linkage system coupled to the frame and configured for movement relative to the frame;
an implement head attached to and supported by the implement linkage system, wherein the implement linkage system is operable to move the implement head relative to the frame to change an elevation of the implement head relative to the ground surface;
a second motion sensor mounted on the implement head at a location defining a head elevation datum, wherein the second motion sensor is configured for detecting data related to movement of the implement head;
wherein the implement head defines a head spacing between the head elevation datum and a ground contact surface of the implement head;
an implement controller including a processor and a memory having a head height determination algorithm stored thereon, wherein the processor is operable to execute the head height determination algorithm to:
determine an offset distance between the traction unit elevation datum and the head elevation datum based on data from the first motion sensor related to movement of the traction unit and data from the second motion sensor related to movement of the implement head;
calculate a head height between the ground surface and the ground contact surface of the implement head by subtracting the offset distance and the head spacing from the traction unit elevation datum; and
control the implement linkage system based on the implement head elevation.

2. The harvester implement set forth in claim 1, wherein the first motion sensor includes an accelerometer operable to measure acceleration.

3. The harvester implement set forth in claim 1, wherein the second motion sensor includes an accelerometer operable to measure acceleration.

4. The harvester implement set forth in claim 1, wherein the processor is operable to execute the head height determination algorithm to determine a pitch angle between the implement head and the frame based on data from the first motion sensor related to movement of the traction unit and data from the second motion sensor related to movement of the implement head.

5. The harvester implement set forth in claim 4, wherein the processor is operable to execute the head height determination algorithm to adjust the implement head height based on the pitch angle.

6. The harvester implement set forth in claim 1, wherein the processor is operable to execute the head height determination algorithm to determine a roll angle of the implement head relative to the frame based on data from the first motion sensor related to movement of the traction unit and data from the second motion sensor related to movement of the implement head.

7. The harvester implement set forth in claim 6, wherein the processor is operable to execute the head height determination algorithm to adjust the implement head height based on the roll angle.

8. The harvester implement set forth in claim 1, wherein the traction unit includes an inflatable tire supporting the frame relative to the ground surface, and a tire pressure sensor configured for sensing a tire pressure of the inflatable tire.

9. The harvester implement set forth in claim 8, wherein the processor is operable to execute the head height determination algorithm to identify a change in the tire pressure of the inflatable tire based on data sensed by the tire pressure sensor.

10. The harvester implement set forth in claim 9, wherein the processor is operable to execute the head height determination algorithm to adjust the traction unit elevation datum based on the change in the tire pressure.

11. The harvester implement set forth in claim 1, wherein the implement head includes a mower mounted to a forward end of the frame, with a blade defining the ground contact surface of the implement head.

12. The harvester implement set forth in claim 1, wherein the implement linkage system includes a hydraulic cylinder selectively controllable between a float operating condition in which the implement linkage system is allowed to move vertically relative to the frame to track the ground surface as the harvester implement moves across the ground surface, and a height control operating condition wherein a length of the hydraulic cylinder is actively controlled to raise the implement head relative to the frame.

13. The harvester implement set forth in claim 12, wherein the processor is operable to execute the head height determination algorithm to control the implement linkage system between one of the float operating condition and the height control operating condition based on the implement head elevation.

14. A mower implement comprising:
a traction unit having a frame, wherein the traction unit is configured for movement across a ground surface;
a first accelerometer mounted on the traction unit at a location defining a traction unit elevation datum, wherein the first accelerometer is configured for detecting data related to movement of the traction unit;
an implement linkage system coupled to the frame adjacent a forward end of the frame, wherein the implement linkage system is configured for movement relative to the frame;
a mower head attached to and supported by the implement linkage system, wherein the implement linkage system is operable to move the mower head relative to the frame to change an elevation of the mower head relative to the ground surface;
a second accelerometer mounted on the mower head at a location defining a head elevation datum, wherein the second accelerometer is configured for detecting data related to movement of the mower head;
wherein the implement head defines a head spacing between the head elevation datum and a ground contact surface of the implement head;
an implement controller including a processor and a memory having a head height determination algorithm stored thereon, wherein the processor is operable to execute the head height determination algorithm to:
determine an offset distance between the traction unit elevation datum and the head elevation datum based on data from the first accelerometer related to movement of the traction unit and data from the second accelerometer related to movement of the implement head; and
calculate a head height between the ground surface and the ground contact surface of the implement head by subtracting the offset distance and the head spacing from the traction unit elevation datum.

15. The mower implement set forth in claim 14, wherein the processor is operable to execute the head height determination algorithm to control the implement linkage system between one of a float operating condition and a height control operating condition based on the implement head elevation.

16. The mower implement set forth in claim 14, wherein the traction unit includes an inflatable tire supporting the frame relative to the ground surface, and a tire pressure sensor configured for sensing a tire pressure of the inflatable tire.

17. The mower implement set forth in claim 16, wherein the processor is operable to execute the head height determination algorithm to identify a change in the tire pressure of the inflatable tire based on data sensed by the tire pressure sensor.

18. The mower implement set forth in claim 17, wherein the processor is operable to execute the head height determination algorithm to adjust the traction unit elevation datum based on the change in the tire pressure.
